(19) United States
(12) Patent Application Publication
(10) Pub. No.: US 2026/0170954 A1
(43) Pub. Date: Jun. 18, 2026

(54) CONTEXTUALLY RECOMMENDING LEVELS OF DRIVING AUTOMATION THROUGH MULTI-VEHICLE COLLABORATION

(71) Applicant: INTERNATIONAL BUSINESS MACHINES CORPORATION, Armonk, NY (US)

(72) Inventors: Satyam JAKKULA, BENGALURU (IN); Charan ACHARYA CHANDRASHEKAR, Bangalore (IN); Rahul RAGHUVANSHI, Indore (IN); Shalini B, Bangalore (IN)

(21) Appl. No.: 18/985,704

(22) Filed: Dec. 18, 2024

(51) Int. Cl. G08G 1/0967; G06N 20/00

(52) U.S. Cl. CPC G08G 1/096708; G06N 20/00

(57) ABSTRACT

A method includes: receiving contextual data from an autonomous vehicle, wherein the contextual data includes data obtained from the autonomous vehicle and data obtained from other vehicles; in response to receiving the contextual data from the autonomous vehicle, determining a level of driving automation that is predicted to provide a highest level of efficiency of the autonomous vehicle based on the contextual data and using a machine learning model; and transmitting, to the autonomous vehicle, a recommendation including the determined level of driving automation.

### BACKGROUND

Aspects of the present invention relate generally to autonomous vehicles. Autonomous vehicles are vehicles such as automobiles that use technology to partially or entirely control driving functions of the vehicle, thereby partially or entirely replacing the human driver in the act of driving the vehicle. Different autonomous vehicles may be equipped with different levels of driving automation. For example, an industry-recognized taxonomy defines six levels of driving automation in the context of motor vehicles and their operation on roadways. The levels include: Level 0 (no driving automation, and the driver is responsible for the vehicle's operation); Level 1 (driver assistance, such as cruise control and lane keeping); Level 2 (partial driving automation, with the driver still in control); Level 3 (conditional driving automation, where the vehicle is in control in some situations, but the driver must take control when requested); Level 4 (high driving automation, where the vehicle is fully autonomous for an entire trip in certain conditions); and Level 5 (full driving automation, where the vehicle is autonomous in all conditions).

### SUMMARY

In a first aspect of the invention, there is a computer-implemented method including: receiving contextual data from an autonomous vehicle, wherein the contextual data includes data obtained from the autonomous vehicle and data obtained from other vehicles; in response to receiving the contextual data from the autonomous vehicle, determining a level of driving automation that is predicted to provide a highest level of efficiency of the autonomous vehicle based on the contextual data and using a machine learning model; and transmitting, to the autonomous vehicle, a recommendation including the determined level of driving automation.

In another aspect of the invention, there is a computer program product comprising one or more computer-readable storage media, and program instructions stored on the one or more computer-readable storage media to perform operations comprising: receiving contextual data from an autonomous vehicle, wherein the contextual data includes data obtained from the autonomous vehicle and data obtained from other vehicles in a multi-vehicle collaboration with the autonomous vehicle; in response to receiving the contextual data from the autonomous vehicle, determining a level of driving automation that is predicted to provide a highest level of efficiency of the autonomous vehicle based on the contextual data and using a machine learning model; and transmitting, to the autonomous vehicle, a recommendation including the determined level of driving automation.

In another aspect of the invention, there is computer system comprising a processor set, one or more computer-readable storage media, and program instructions stored on the one or more computer-readable storage media to cause the processor set to perform operations comprising: receiving contextual data from an autonomous vehicle, wherein the contextual data includes data obtained from the autonomous vehicle, data obtained from one or more Internet-of-Things sensors along a roadway on which the autonomous vehicle is driving, and data obtained from other vehicles on the roadway on which the autonomous vehicle is driving; in response to receiving the contextual data from the autonomous vehicle, determining a level of driving automation that is predicted to provide a highest level of efficiency of the autonomous vehicle based on the contextual data and using a machine learning model; and transmitting, to the autonomous vehicle, a recommendation including the determined level of driving automation.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to autonomous vehicles and, more particularly, to contextually recommending levels of driving automation through multi-vehicle collaboration. According to aspects of the invention, a system and method are configured to receive contextual data from an autonomous vehicle, determine a level of driving automation that results in optimal efficiency of the autonomous vehicle based on the contextual data, and recommend the determined level of driving automation to the autonomous vehicle. In embodiments, the system and method utilize a knowledge base that relates vehicle efficiency to level of driving automation in different contexts. In embodiments, the contextual data includes data from the vehicle itself and from other vehicles in a multi-vehicle collaborative environment. In this manner, implementations of the invention are useful for determining and recommending a level of driving automation to an autonomous vehicle to achieve optimal efficiency for the autonomous vehicle based on the current context of the autonomous vehicle.

The continued development of autonomous vehicles promises a transportation revolution, with enhanced safety, reduced traffic congestion, and improved efficiency. However, individual autonomous vehicles navigating complex environments still face limitations, particularly in areas with unpredictable scenarios or insufficient sensor data. To address these challenges, multi-vehicle collaboration has emerged as a promising approach. In this paradigm, autonomous vehicles share information and coordinate their actions, leveraging collective intelligence to overcome individual limitations and optimize performance.

While multi-vehicle collaboration offers significant potential, a key challenge lies in dynamically adapting the level of autonomy for each vehicle within the group. Current systems often employ a static approach, assigning a fixed autonomy level (e.g., Level 2 or Level 4) to each vehicle regardless of the context. This can lead to several drawbacks. One such drawback is inefficient resource allocation. If high-autonomy vehicles encounter situations requiring human intervention, the system's overall efficiency suffers. Conversely, underutilizing advanced capabilities in simpler scenarios can limit the potential benefits of collaboration. Another drawback in this context is limited adaptability to dynamic environments. Unforeseen events or changes in road conditions can overwhelm low-autonomy vehicles, requiring human intervention and disrupting collaboration. Another drawback in this context is reduced safety and trust. Mismatches between autonomy levels and situational complexity can compromise safety and undermine user trust in the system. Therefore, a need exists for a dynamic and context-aware system that can adjust the autonomy level of each autonomous vehicle within a collaborative network based on real-time information and environmental demands.

Implementations of the invention address these problems and this need by providing a system and method for contextually recommending levels of driving automation through multi-vehicle collaboration by: receiving contextual data from an autonomous vehicle, wherein the contextual data includes data from the vehicle itself and from other vehicles in a multi-vehicle collaborative environment; determining a level of driving automation that results in optimal efficiency of the autonomous vehicle based on the contextual data and using a knowledge base that relates vehicle efficiency to level of driving automation in different contexts; and recommending the determined level of driving automation to the autonomous vehicle. Implementations provide highly efficient resource allocation by learning and recommending levels of driving automation to achieve optimal efficiency in different driving contexts. This represents an improvement over systems that suffer from inefficient resource allocation due to such systems employing a static approach to levels of driving automation. Implementations also provide a high degree of adaptability to dynamic environments by learning and recommending levels of driving automation to achieve optimal efficiency in different driving contexts. This represents an improvement over systems that suffer from limited adaptability to dynamic environments due to such systems employing a static approach to levels of driving automation.

In accordance with aspects of the invention, a system and method for contextually recommending levels of driving automation (also referred to herein as autonomous levels) through multi-vehicle collaboration are configured to: build an efficiency versus autonomous level knowledge base; receive sensor data and environment data from vehicles; and recommend autonomous level to achieve maximum efficiency (e.g., miles per gallon, miles per kilowatt hour (kWh), etc.). In embodiments, the efficiency versus autonomous level knowledge base is built by collecting past trip information from various vehicles containing details such as vehicle type, age, road condition, weather condition, autonomous level used, efficiency achieved, etc. In embodiments, current contextual data for a vehicle (e.g., for a current trip) includes vehicle details obtained from built-in vehicular sensors and environment data collected from road-side units such as road-side Internet-of-Things (IoT) sensors. In embodiments, the contextual data is processed to extract key features, and a query to the knowledge base is built using the extracted key features. In embodiments, the query including the extracted key features is provided to the knowledge base, which determines the optimal autonomous level for the current context of the vehicle.

Implementations of the invention are necessarily rooted in computer technology. For example, the steps of training a machine learning model using training data, and the machine learning model outputting a level of driving automation based on receiving an input query, are computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, vehicle sensor data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the level of driving automation recommendation code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

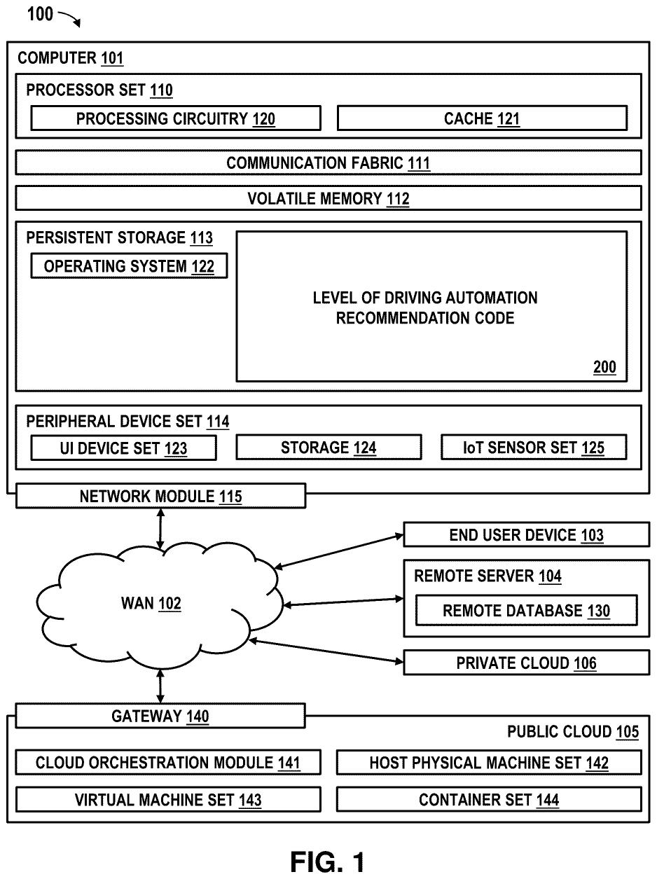

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

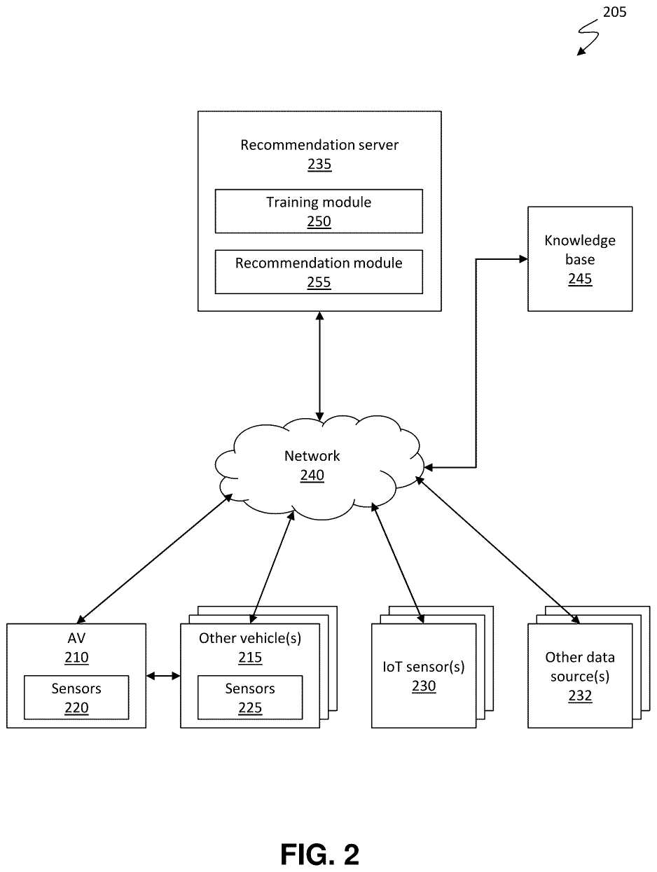

FIG. 2 shows a block diagram of an exemplary environment 205 in accordance with aspects of the invention. In embodiments, the environment 205 includes an autonomous vehicle (AV) 210 and one or more other vehicles 215 in a multi-vehicle collaborative environment. In embodiments, each of the autonomous vehicle 210 and the one or more other vehicles 215 comprises a computing system, such as an instance of the EUD 103, that includes at least a computer processor, computer memory, and wireless communication system. The respective computer systems in the autonomous vehicle 210 and the one or more other vehicles 215 may comprise an on-board computer (e.g., integrated in the vehicle itself) or a mobile device such as a cellular telephone. In embodiments, the autonomous vehicle 210 and the one or more other vehicles 215 communicate with one another via a vehicle-to-vehicle (V2V) network or vehicle-to-infrastructure (V2I) network.

In accordance with aspects of the invention, the autonomous vehicle 210 is capable of being switched between different levels of driving automation. In embodiments, the different levels of driving automation are industry standard levels including Level 0, Level 1, Level 2, Level 3, Level 4, and Level 5, although other sets of levels may be used. In one example, the autonomous vehicle 210 may be switched from one level of driving automation to another based on user input, e.g., the driver the autonomous vehicle 210 providing an input to the autonomous vehicle 210. In another example, the driver of the autonomous vehicle 210 may configure settings of the autonomous vehicle 210 that permit the autonomous vehicle 210 to be switched from one level of driving automation to another automatically via the computing system in the autonomous vehicle 210 without any input from the driver to effectuate the switch.

In accordance with aspects of the invention, the environment 205 includes various data sources that generate data that is accessible by the autonomous vehicle 210. In embodiments, the data sources in the environment 205 include: one or more sensors 220 included in (e.g., onboard) the autonomous vehicle 210; one or more sensors 225 in the one or more other vehicles 215; one or more Internet-of-Things (IoT) sensors 230 along the roadway on which the autonomous vehicle 210 is traveling; and one or more other data sources 232 such as online navigation services, online traffic services, and online weather services. The sensors 220 and 225 may detect vehicle-related data including but not limited to: type of vehicle; vehicle age; vehicle condition; vehicle speed; tire pressure; engine temperature; vehicle capabilities (e.g., sensor range and processing power); and emissions (e.g., carbon output). The IoT sensors 230 and other data sources 232 may detect or be programmed to report environmental conditions along the roadway on which the autonomous vehicle 210 is driving, including but not limited to: ambient temperature; ambient barometric pressure; ambient humidity; fog amount; visibility; wind speed; wind direction; rain amount; snow amount; road type (e.g., highway, urban, rural); traffic density and flow; road surface conditions (e.g., dry, wet, snow, etc.); road surface composition (e.g., pavement, concrete, gravel, dirt, etc.); road surface quality (e.g., smooth, bumpy, potholes, etc.); road terrain (e.g., flat, hilly, mountainous, etc.); road shape (e.g., straight, curvy, winding, etc.); regulations applicable for the location in which the autonomous vehicle 210 is driving; and safety considerations.

In accordance with aspects of the invention, the environment 205 includes a recommendation server 235 that is in wireless communication with the autonomous vehicle 210 and other devices in the environment 205 via a network 240. The network 240 may comprise one or more networks such as the WAN 102 of FIG. 1. The recommendation server 235 comprises one or more computing systems such as one or more instances of the computer 101 of FIG. 1, in one example. In another example, the recommendation server 235 comprises one or more virtual machines or one or more containers running on one or more instances of the computer 101 of FIG. 1. In various embodiments, the recommendation server 235 includes or communicates with a knowledge base 245, which may comprise one or more instances of the remote database 130 of FIG. 1.

In embodiments, the recommendation server 235 of FIG. 2 comprises a training module 250 and a recommendation module 255, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The recommendation server 235 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the training module 250 is configured to train a predictive machine learning model using data in the knowledge base 245. In accordance with aspects of the invention, the recommendation module 255 is configured to receive a query from the autonomous vehicle 210 and respond to the query by providing a recommended level of driving automation to the autonomous vehicle 210, wherein the recommended level of driving automation is determined by the recommendation module 255 to achieve a highest level of efficiency for the autonomous vehicle 210 based on the current context in which the autonomous vehicle 210 is driving. In various embodiments, efficiency for the autonomous vehicle 210 is defined in terms of miles per gallon or miles per kWh.

In accordance with aspects of the invention, the knowledge base 245 receives and stores raw data for the purpose of training the predictive machine learning model. In embodiments, the raw data is received in the form of historic datasets received from a population of vehicles that may include but is not limited to the autonomous vehicle 210 and the one or more other vehicles 215. In embodiments, a historic dataset from a vehicle may include “m” number of values of data corresponding to m number of data points. The m number of data points may include environmental data related to weather or environmental conditions outside the vehicle, such as: ambient temperature; ambient barometric pressure; ambient humidity; fog amount; visibility; wind speed; wind direction; rain amount; snow amount. The m number of data points may also include vehicular data, such as: type of vehicle; vehicle age; vehicle condition; vehicle speed; tire pressure; engine temperature; vehicle capabilities (e.g., sensor range and processing power); emissions (e.g., carbon output); level of driving automation; and engine efficiency. Level of driving automation of the vehicle (e.g., one of Levels 0-5) and engine efficiency of the vehicle (e.g., miles per gallon or miles per kWh) may be determined by an on-board computer system in the vehicle. The m number of data points may also include road condition data that characterizes the road on which a vehicle is driving, such as: road type (e.g., highway, urban, rural); traffic density and flow; road surface conditions (e.g., dry, wet, snow, etc.); road surface composition (e.g., pavement, concrete, gravel, dirt, etc.); road surface quality (e.g., smooth, bumpy, potholes, etc.); road terrain (e.g., flat, hilly, mountainous, etc.); road shape (e.g., straight, curvy, winding, etc.); regulations applicable for the location in which the vehicle is driving; and safety considerations. These examples of types of data included in a historic dataset from a vehicle are for illustrative purposes and are not limiting, and a historic dataset from a vehicle may have dozens of even hundreds of different types of data.

A respective historic dataset comprises data obtained by a respective vehicle corresponding to a respective point in time. Values of the data included in a historic dataset may be obtained from different data sources including but not limited to: sensors in an autonomous vehicle, such as but not limited to sensors 220 in the autonomous vehicle 210; sensors in other vehicles, such as but not limited to sensors 225 in the one or more other vehicles 215; IoT sensors along roadways, such as IoT sensors 230; and other data sources 232.

A single vehicle may create plural different historic datasets corresponding to different points in time, where a respective one of the historic datasets includes values of data associated with (e.g., obtained at or near) a respective one of the points in time. In embodiments, the knowledge base 245 receives and stores historic datasets from plural different vehicles.

In accordance with aspects of the invention, the training module 250 accesses the knowledge base 245 and creates a predictive machine learning model using data from the historic datasets from the different vehicles. In embodiments, the predictive machine learning model is a machine learning model that is trained to predict a level of driving automation for a vehicle that will achieve a highest level of efficiency for the vehicle based on a set of contextual data associated with the vehicle. In embodiments, the predictive machine learning model is trained using training data that is created from the historic datasets stored in the knowledge base 245. In one example, the training data includes plural feature vectors, where a respective one of the feature vectors includes values derived from a respective historic dataset stored in the knowledge base 245. In one example, each feature vector has n+2 number of dimensions corresponding to features F1, F2, . . . , Fn, Fn+1, Fn+2, where “n” is an integer. In a feature vector, the values of features F1, F2, . . . , Fn are values of contextual data from a historic dataset from a vehicle, Fn+1 is a level of driving automation of the vehicle from the same historic dataset, and Fn+2 is a value of a measure of efficiency of the vehicle from the same historic dataset. In embodiments, the training module 250 uses a machine learning training algorithm with the training data to train a machine learning model that is configured to predict a level of driving automation that achieves a highest level of efficiency based on an input set of values corresponding to features F1, F2, . . . , Fn. The predictive machine learning model may comprise a decision tree model, a random forest model, or an artificial neural network, for example.

In accordance with aspects of the invention, the features F1, F2, . . . , Fn in the feature vectors of the training data are key features that represent a subset of the m number of features (e.g., types of data) in the historic datasets. In embodiments, the training module 250 determines which ones of the m number of features of the historic datasets to use as the features F1, F2, . . . , Fn using a feature selection algorithm or a feature extraction algorithm. In one example, the training module 250 identifies the key features (i.e., the subset of features from the m number of features to use as the features F1, F2, . . . , Fn) using a recursive feature elimination (RFE) algorithm, which is a type of feature selection algorithm that selects the most important features by recursively removing the least important features and retraining the model. Selecting the most relevant features from the raw data in this manner, while discarding the irrelevant or redundant features, is used in embodiments to improve the accuracy and efficiency of the predictive machine learning model.

In accordance with aspects of the invention, after training the predictive machine learning model using the training data, the recommendation server 235 receives queries from vehicles and responds to the queries with a recommended level of driving automation to achieve a highest level of efficiency (e.g., an optimal efficiency) for the requesting vehicle. In embodiments, a query (or request) from a vehicle includes a query dataset that has values for features F1, F2, . . . , Fn that are based on contextual data associated with the vehicle. In embodiments, a vehicle such as the autonomous vehicle 210 obtains its contextual data from data sources such as the sensors 220 included in the autonomous vehicle 210, the sensors 225 in the one or more other vehicles 215 on the roadway near the autonomous vehicle 210 vehicle (e.g., in a multi-vehicle collaborative network), the IoT sensors 230 along the roadway on which the vehicle is traveling, and the other data sources 232. The contextual data for the autonomous vehicle 210 may include some or all of the m number of types of data in the historic datasets, e.g., some or all the different types of vehicular data, road condition data, and environmental data described above. The contextual data for the autonomous vehicle 210 may even include types of data that are not included in the m number of types of data in the historic datasets. In accordance with aspects of the invention, the autonomous vehicle 210 creates a query dataset based on the contextual data. In embodiments, the autonomous vehicle 210 extracts values of the key features (e.g., features F1, F2, . . . , Fn) from the contextual data, and populates the query dataset with these values. For example, the query dataset may include a value QF1 that corresponds to the feature F1, a value QF2 that corresponds to the feature F2, and a value of QFn that corresponds to the feature Fn.

In accordance with aspects of the invention, the autonomous vehicle 210 sends the query dataset to the recommendation server 235, and the recommendation module 255 applies the query dataset as an input to the trained predictive machine learning model. The predictive machine learning model generates an output based on the query dataset input, the output comprising a level of driving automation (e.g., a value corresponding to driving autonomy Level 0, Level 1, Level 2, Level 3, Level 4, or Level 5) that is determined by the predictive machine learning model to provide a highest level of efficiency for the autonomous vehicle 210 based on the current context of the autonomous vehicle 210. In embodiments, the recommendation server 235 sends, to the autonomous vehicle 210, data defining the level of driving automation that was output by the predictive machine learning model based on the query dataset. In this manner, the recommendation server 235 provides a recommended level of driving automation to the autonomous vehicle 210, wherein the recommended level of driving automation is a level determined to provide the most efficient operation of the autonomous vehicle 210 based on the current context of the autonomous vehicle 210.

In accordance with aspects of the invention, the autonomous vehicle 210 receives the recommended level of driving automation and switches to the recommended level of driving automation. In one example, the switch may be performed manually by the driver of the autonomous vehicle 210. In this example, the autonomous vehicle 210 provides an alert to the driver, e.g., via a video display and/or audio device, where the alert notifies the driver of the recommended level of driving automation. The driver then provides input to the control system of the autonomous vehicle 210 to cause the autonomous vehicle 210 to switch from its current level of driving automation to the recommended level of driving automation. In another example, the switch may be performed automatically by the autonomous vehicle 210 without being based on input from the driver of the autonomous vehicle 210.

In accordance with further aspects of the invention, the autonomous vehicle 210 provides feedback to the knowledge base 245 after switching to the recommended level of driving automation. The feedback may include a new historic dataset for the autonomous vehicle 210 at the current time, may be stored in the knowledge base 245, and may be used as the basis for training data when updating (e.g., retraining) the predictive machine learning model. In this manner, embodiments use reinforcement learning to improve the predictive machine learning model.

Implementations have been described thus far in which the autonomous vehicle 210 creates the query dataset and sends the query dataset to the recommendation server 235. However, in other implementations, the recommendation server 235 creates the query dataset. In these other implementations, the autonomous vehicle 210 sends its contextual data to the recommendation server 235 in unprocessed form, e.g., in a form similar to the historic datasets described herein. In these implementations, the recommendation module 255 determines the key features from the contextual data received from the autonomous vehicle 210 and creates the query dataset based on these key features. The recommendation module 255 then proceeds to apply the query dataset as an input to the predictive machine learning model in the manner already described herein. In this manner, the processing performed in creating the query dataset from the contextual data is offloaded from the autonomous vehicle 210 to the recommendation server 235.

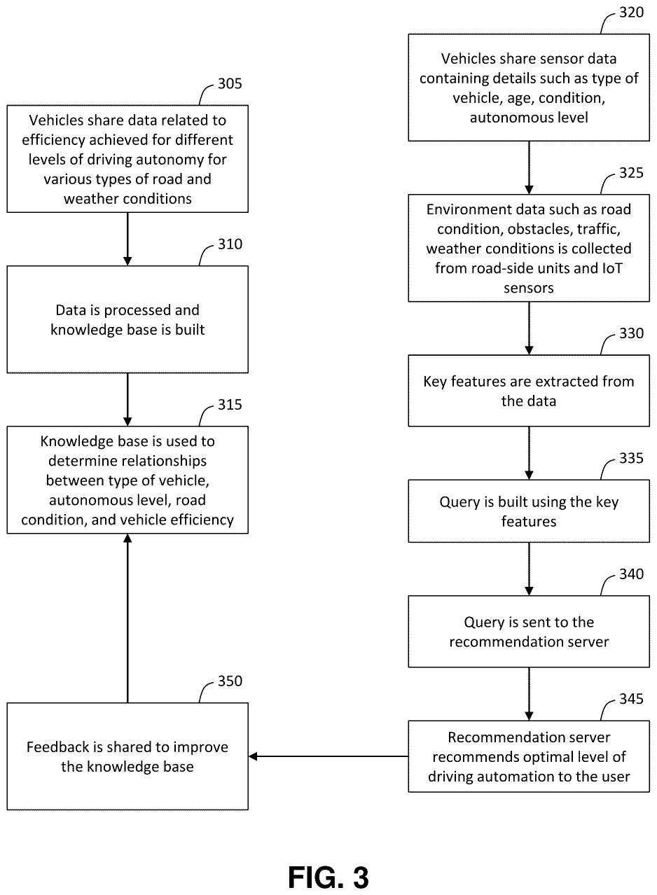

FIG. 3 shows a flowchart of an exemplary method in accordance with aspects of the present invention. Steps of the method (also referred to herein as operations) may be carried out in the environment of FIG. 2 and are described with reference to elements depicted in FIG. 2.

At step 305 vehicles share data related to efficiency achieved for different levels of driving autonomy for various types of road and weather conditions. This may correspond to the vehicles sending historic datasets to the knowledge base. At step 310 the data received from the vehicles is processed and the knowledge base is built. This may correspond to the training module determining key features from the raw data and creating training data including the key features. At step 315 the knowledge base is used to determine relationships between type of vehicle, autonomous level, road condition, and vehicle efficiency. This may correspond to training the predictive machine learning model using the training data.

At step 320 vehicles share sensor data containing details such as type of vehicle, age, condition, autonomous level. This may correspond to the autonomous vehicle 210 and one or more other vehicles 215 sharing data in a multi-vehicle collaborative environment. At step 325 environment data such as road condition, obstacles, traffic, weather conditions is collected from road-side units and IoT sensors. This may correspond to the autonomous vehicle 210 obtaining data from the IoT sensors 230 and other data sources 232. At step 330 key features are extracted from the data, and at step 335 a query is built using the key features. These steps may correspond to the autonomous vehicle 210 creating a query dataset. At step 340 the query is sent to the recommendation server. This may correspond to the autonomous vehicle 210 sending the query dataset to the recommendation server. At step 345 the recommendation server recommends an optimal level of driving automation to the user. This may correspond to the recommendation server determining a level of driving automation using the query dataset and the predictive machine learning model, and the recommendation server recommending that determined level of driving automation to the autonomous vehicle 210. At step 350 feedback is shared to improve the knowledge base. This may correspond to the autonomous vehicle 210 providing feedback to the knowledge base 245 after switching to the recommended level of driving automation.

Embodiments described thus far provide a system and method that work on cooperative perception and shared sensor data. Autonomous vehicles participating in the system can share sensor data like Light Detection and Ranging (LiDAR) or radar readings and data from cameras. Apart from sensor data, real-time data related to digital maps, traffic information, weather data and driver input are considered. Implementations of the system and method thus provide a more comprehensive and accurate picture of the environment which is required for better route planning, obstacle avoidance, and traffic flow optimization, leading to energy-efficient maneuvers. In embodiments, autonomous vehicles communicate with other vehicles in a multi-vehicle collaborative environment using V2V and V2I for better decision making. The participating vehicles share information about position, velocity, intent, sensor data and planned actions. In embodiments, the knowledge base is built by collecting multiple vehicles past trip details, and the knowledge base contain details about efficiency achieved through various autonomous level for a given type of road and weather condition. Implementations of the system and method process collected data to extract relevant features for modelling context. These features may include: road type (e.g., highway, urban, rural); traffic density and flow; weather conditions (e.g., sunny, rainy, foggy, etc.); visibility; terrain (e.g., flat, hilly, mountainous); regulations applicable for geographic location; vehicle capabilities (e.g., sensor range, processing power); and safety considerations. In embodiments, a feature selection and modeling method identifies the most influential features for driving automation level decisions. Implementations of the system and method utilize automotive engineering domain knowledge, traffic flow analysis and environmental science to identify key factors influencing energy-efficient and suitable automation levels. In embodiments, the system and method develop a predictive machine learning model using machine learning techniques such as decision tree or random forests to model complex relationships to arrive at the context of driving automation level. The system and method may also use artificial neural networks to capture non-linear patterns and learn from large datasets of multi-vehicles participation. The system and method may use reinforcement learning methods for continuous decision making and adaptation to changing environments and features. In embodiments, the system and method predict a level of driving automation (Level 0, Level 1, . . . , Level 5) the context of a vehicle to provide optimally energy efficient driving for the vehicle.

The following example illustrate aspects of the disclosure. In the context of terrain flat roads favor higher automation (Level 4 or Level 5), whereas hilly or mountainous terrain might benefit from a lower level (Level 2 or Level 3) for better handling and regenerative braking opportunities. Considering weather, sunny and dry conditions generally favor higher automation, while rain, snow, or fog are better served using lower levels for improved driver visibility and control. Considering wind, tailwinds could allow for higher automation with reduced fuel consumption, while headwinds might benefit from lower levels for optimal fuel management. In the context of traffic density, heavy traffic often benefits from Level 3 or 4 automation for adaptive cruise control and stop-and-go capabilities, reducing frequent acceleration and braking. Light traffic might be more efficient with Level 2 for driver engagement and adjusting to unexpected situations. Considering traffic flow, consistent traffic flow allows for efficient platooning (Level 4 or 5) where vehicles closely follow each other, reducing aerodynamic drag and optimizing fuel consumption. Inconsistent flow might be better suited for lower levels for individual maneuvering and adjusting to gaps.

Embodiments described thus far provide for transition between different levels of driving automations to be handled safely and smoothly. Regulatory requirements in specific regions, energy efficiency goals may be considered by the system. In embodiments, the suggested driving automation level is communicated to the vehicle control system. The system may collect feedback data for continuous improvement of the algorithm and retraining of the model. The vehicle control system may integrate feedback loops to adapt to changing conditions and driving styles.

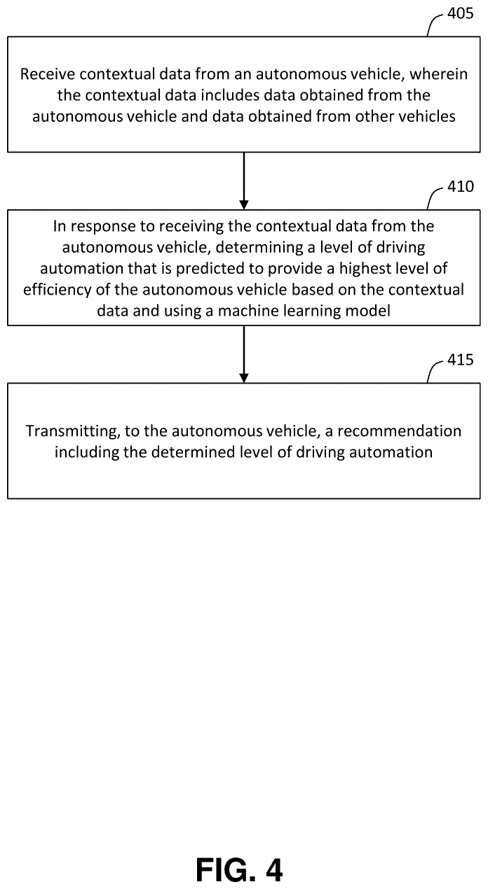

FIG. 4 shows a flowchart of an exemplary method in accordance with aspects of the present invention. Steps of the method (also referred to herein as operations) may be carried out in the environment of FIG. 2 and are described with reference to elements depicted in FIG. 2.

At step 405 the system receives contextual data from an autonomous vehicle, wherein the contextual data includes data obtained from the autonomous vehicle and data obtained from other vehicles. In embodiments, and as described with respect to FIG. 2, the recommendation server 235 receives contextual data from the autonomous vehicle 210. The contextual data may include data that has not been processed into a query dataset, or may include a query dataset that has been already been created.

At step 410, in response to receiving the contextual data from the autonomous vehicle, the system determines a level of driving automation that is predicted to provide a highest level of efficiency of the autonomous vehicle based on the contextual data and using a machine learning model. In embodiments, and as described with respect to FIG. 2, the recommendation server 235 uses the predictive machine learning model to determine a level of driving automation for the autonomous vehicle 210 that will provide a highest level of efficiency for the autonomous vehicle 210 based on the contextual data of the autonomous vehicle 210 from step 405.

At step 415 the system transmits, to the autonomous vehicle, a recommendation including the determined level of driving automation from step 410. In embodiments, the recommendation server 235 recommends the determined level of driving automation to the autonomous vehicle 210.

In embodiments, the method further comprises: determining key features from the contextual data; and creating a query that includes values of the key features. In embodiments, the method further comprises applying the query as an input to the machine learning model.

In embodiments, the method further comprises: receiving feedback from the autonomous vehicle based on the autonomous vehicle switching to the determined level of driving automation; and re-training the machine learning model using the feedback.

In embodiments, the method further comprises: creating a knowledge base including historic data from plural vehicles; determining key features in the historic data; creating training data from the historic data, wherein the training data includes the key features; and training the machine learning model using the training data.

In embodiments of the method, the contextual data includes vehicular data, road condition data, and environmental data.

In embodiments of the method, the machine learning model is trained to predict an optimal level of driving automation for a vehicle that will achieve a highest level of efficiency for the vehicle based on a set of contextual data associated with the vehicle.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving contextual data from an autonomous vehicle, wherein the contextual data includes data obtained from the autonomous vehicle and data obtained from other vehicles;
in response to receiving the contextual data from the autonomous vehicle, determining a level of driving automation that is predicted to provide a highest level of efficiency of the autonomous vehicle based on the contextual data and using a machine learning model; and
transmitting, to the autonomous vehicle, a recommendation including the determined level of driving automation.

2. The computer-implemented method of claim 1, further comprising:
determining key features from the contextual data; and
creating a query that includes values of the key features.

3. The computer-implemented method of claim 2, further comprising applying the query as an input to the machine learning model.

4. The computer-implemented method of claim 1, further comprising:
receiving feedback from the autonomous vehicle based on the autonomous vehicle switching to the determined level of driving automation; and
re-training the machine learning model using the feedback.

5. The computer-implemented method of claim 1, further comprising:
creating a knowledge base including historic data from plural vehicles;
determining key features in the historic data;
creating training data from the historic data, wherein the training data includes the key features; and
training the machine learning model using the training data.

6. The computer-implemented method of claim 1, wherein the contextual data includes vehicular data, road condition data, and environmental data.

7. The computer-implemented method of claim 1, wherein the machine learning model is trained to predict an optimal level of driving automation for a vehicle that will achieve a highest level of efficiency for the vehicle based on a set of contextual data associated with the vehicle.

8. A computer program product comprising:
one or more computer-readable storage media; and
program instructions stored on the one or more computer-readable storage media to perform operations comprising:
receiving contextual data from an autonomous vehicle, wherein the contextual data includes data obtained from the autonomous vehicle and data obtained from other vehicles in a multi-vehicle collaboration with the autonomous vehicle;
in response to receiving the contextual data from the autonomous vehicle, determining a level of driving automation that is predicted to provide a highest level of efficiency of the autonomous vehicle based on the contextual data and using a machine learning model; and
transmitting, to the autonomous vehicle, a recommendation including the determined level of driving automation.

9. The computer program product of claim 8, wherein the operations further comprise:
determining key features from the contextual data;
creating a query that includes values of the key features; and
applying the query as an input to the machine learning model.

10. The computer program product of claim 8, wherein the operations further comprise:
receiving feedback from the autonomous vehicle based on the autonomous vehicle switching to the determined level of driving automation; and
re-training the machine learning model using the feedback.

11. The computer program product of claim 8, wherein the operations further comprise:
creating a knowledge base including historic data from plural vehicles;
determining key features in the historic data;
creating training data from the historic data, wherein the training data includes the key features; and
training the machine learning model using the training data.

12. The computer program product of claim 8, wherein the contextual data includes vehicular data, road condition data, and environmental data.

13. The computer program product of claim 8, wherein the machine learning model is trained to predict an optimal level of driving automation for a vehicle that will achieve a highest level of efficiency for the vehicle based on a set of contextual data associated with the vehicle.

14. The computer program product of claim 8, wherein the contextual data further includes data obtained from one or more Internet-of-Things sensors along a roadway on which the autonomous vehicle is driving.

15. A computer system comprising:
a processor set;
one or more computer-readable storage media; and
program instructions stored on the one or more computer-readable storage media to cause the processor set to perform operations comprising:
receiving contextual data from an autonomous vehicle, wherein the contextual data includes data obtained from the autonomous vehicle, data obtained from one or more Internet-of-Things sensors along a roadway on which the autonomous vehicle is driving, and data obtained from other vehicles on the roadway on which the autonomous vehicle is driving;
in response to receiving the contextual data from the autonomous vehicle, determining a level of driving automation that is predicted to provide a highest level of efficiency of the autonomous vehicle based on the contextual data and using a machine learning model; and
transmitting, to the autonomous vehicle, a recommendation including the determined level of driving automation.

16. The computer system of claim 15, wherein the operations further comprise:
determining key features from the contextual data;
creating a query that includes values of the key features; and
applying the query as an input to the machine learning model.

17. The computer system of claim 15, wherein the operations further comprise:
receiving feedback from the autonomous vehicle based on the autonomous vehicle switching to the determined level of driving automation; and
re-training the machine learning model using the feedback.

18. The computer system of claim 15, wherein the operations further comprise:
creating a knowledge base including historic data from plural vehicles;
determining key features in the historic data;
creating training data from the historic data, wherein the training data includes the key features; and
training the machine learning model using the training data.

19. The computer system of claim 15, wherein the contextual data includes vehicular data, road condition data, and environmental data.

20. The computer system of claim 15, wherein the machine learning model is trained to predict an optimal level of driving automation for a vehicle that will achieve a highest level of efficiency for the vehicle based on a set of contextual data associated with the vehicle.
